(19) United States
(12) Patent Application Publication
(10) Pub. No.: US 2025/0112727 A1
(43) Pub. Date: Apr. 3, 2025

(54) LOW POWER INDOOR (LPI) ACCESS POINT (AP) THAT PUNCTURES ITS CHANNEL WHILE RESPECTING INCUMBENTS

(71) Applicant: Cisco Technology, Inc., San Jose, CA (US)

(72) Inventors: Brian D. Hart, Sunnyvale, CA (US); William H. Davenport, McLean, VA (US); Scott Ross Blue, Espoo (FI); Nedime Pelin Mohamed Hassan Salem, San Jose, CA (US)

(73) Assignee: Cisco Technology, Inc., San Jose, CA (US)

(21) Appl. No.: 18/902,408

(22) Filed: Sep. 30, 2024

Related U.S. Application Data
(60) Provisional application No. 63/586,305, filed on Sep. 28, 2023.
(60) Provisional application No. 63/666,286, filed on Jul. 1, 2024.
(60) Provisional application No. 63/672,672, filed on Jul. 17, 2024.

(51) Int. Cl. H04L 1/00; H04W 74/0833; H04W 88/08

(52) U.S. Cl. CPC H04L 1/0013; H04L 1/0069; H04W 74/085; H04W 88/08

(57) ABSTRACT

A Low Power Indoor (LPI) Access Point (AP) that punctures its channel while respecting incumbents may be provided. First, a computing device may determine a relaxation value. Then an energy detection Clear Channel Assessment (CCA) threshold may be changed by the relaxation value for a punctured subchannel. Next, the punctured subchannel may be reported as busy when energy is detected in the punctured subchannel above the changed energy detection CCA threshold.

### RELATED APPLICATION TECHNICAL FIELD

Under provisions of 35 U.S.C. § 119 (e), Applicant claims the benefit of U.S. Provisional Application No. 63/586,305 filed Sep. 28, 2023, which is incorporated herein by reference. In addition, under provisions of 35 U.S.C. § 119 (e), Applicant claims the benefit of U.S. Provisional Application No. 63/666,286 filed Jul. 1, 2024, which is incorporated herein by reference. Furthermore, under provisions of 35 U.S.C. § 119 (e), Applicant claims the benefit of U.S. Provisional Application No. 63/672,672 filed Jul. 17, 2024, which is incorporated herein by reference.

### TECHNICAL FIELD

The present disclosure relates generally to providing a Low Power Indoor (LPI) Access Point (AP) that punctures its channel while respecting incumbents.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing a Low Power Indoor (LPI) Access Point (AP) that punctures its channel while respecting incumbents;

FIG. 2 is a flow chart of a method for providing an LPI AP that punctures its channel while respecting incumbents; and

FIG. 3 is a block diagram of a computing device.

### DETAILED DESCRIPTION

### Overview

A Low Power Indoor (LPI) Access Point (AP) that punctures its channel while respecting incumbents may be provided. First, a computing device may determine a relaxation value. Then an energy detection Clear Channel Assessment (CCA) threshold may be changed by the relaxation value for a punctured subchannel. Next, the punctured subchannel may be reported as busy when energy is detected in the punctured subchannel above the changed energy detection CCA threshold.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Low Power Indoor (LPI) and Standard Power (SP) are two classes of Wi-Fi APs that differ in their power levels and how they operate. LPI APs may be designed for fixed indoor use and operate at lower power levels. The APs may be intended to minimize interference and optimize spectrum utilization in dense indoor environments. LPI APs may be required to be installed in a fixed location, have permanently attached antennas, and be powered by a wired connection. SP APs may operate indoors or outdoors at full power. They may be designed to provide extended coverage and range, making them suitable for larger indoor spaces and outdoor deployments. SP APs may be controlled by an Automated Frequency Coordination (AFC) database to mitigate interference with other services (i.e., incumbents).

Consider an LPI AP operating an 80 MHz Basic Service Set (BSS) made up of four 20 MHz subchannels that may be designated by [P20, S20, S40a, S40b] (e.g., lowest to highest frequency ordering). There may be an incumbent on the S40a subchannel. Puncturing in the Institute of Electrical and Electronics Engineers (IEEE) 802.11ax/be standard (i.e., sensing a clear channel on [P20, S20, x, S40b] then transmitting on [P20, S20, x, S40b], but not sensing or transmitting on [x, x, S40a, x]) was designed to transmit around the incumbent while avoiding causing interference to the incumbent. However, this process was rejected by the United States (US) Federal Communications Commission (FCC) for LPI APs. The FCC prohibits LPI APs from puncturing their channels because, in their view, puncturing may not protect incumbents.

This may be inconsistent because the LPI AP is already allowed to transmit at LPI power over the full 80 MHZ, so puncturing S40a may comprise a courtesy. However, the FCC's reasoning is that the LPI APs (and their client devices) need to perform contention-based channel access, so given any decent interference power over S40a (e.g., and it is spectrally clean so is not seen over P20/S20/S40b), the client devices may have to defer, albeit transmit on the P40 (i.e., [P20 S20]) and create “one-sided” interference that may be a minor improvement over the two-side interference from a [P20, S20, x, S40b] transmission. Therefore embodiments of the disclosure may seek a way for an LPI AP to transmit on [P20, S20, x, S40b] while still protecting incumbents. Embodiments of the disclosure may allow LPI APs to use punctured channels in a way that satisfies regulators and is implementable by Wi-Fi devices, but relaxing (raising) the CCA threshold over a punctured channel by an amount related to the depth of the Transmit (TX) Power Spectral Density (PSD) suppression over the punctured channel.

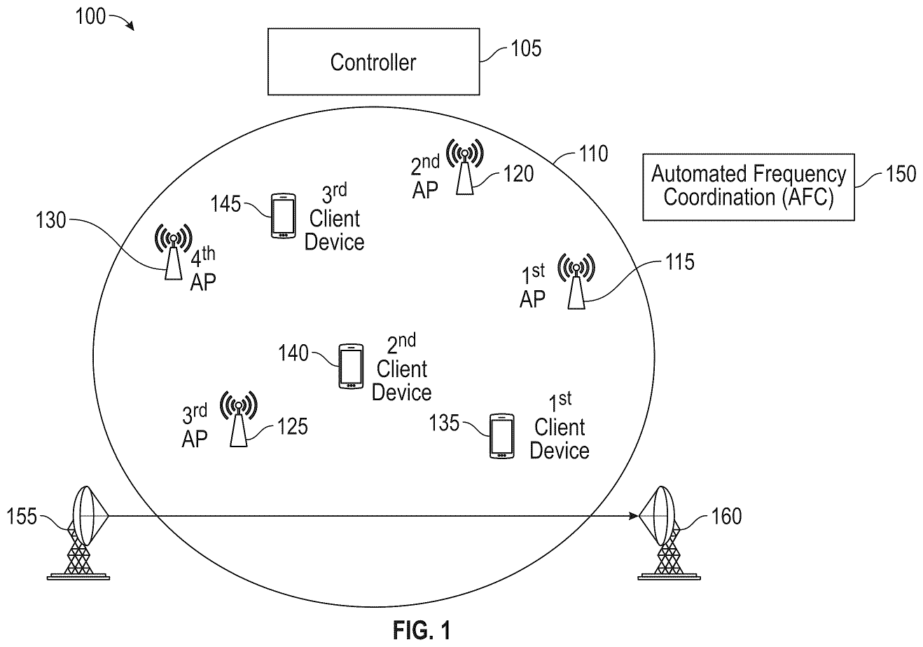

FIG. 1 shows an operating environment 100 for providing a Low Power Indoor (LPI) Access Point (AP) that punctures its channel while respecting incumbents. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125, and a fourth AP 130. The plurality of APs may provide wireless network access to a plurality of client devices as they move within coverage environment 110. The plurality of client devices may comprise, but are not limited to, a first client device 135, a second client device 140, and a third client device 145. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the IEEE 802.11 specification standard for example.

The plurality of APs and the plurality of client devices may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless Local Area Network controller (WLC) and may provision and control coverage environment 110 (e.g., a WLAN). Controller 105 may allow first client device 135, second client device 140, and third client device 145 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide a Low Power Indoor (LPI) Access Point (AP) that punctures its channel while respecting incumbents.

In order for unlicensed devices (e.g., Wi-Fi devices such as client devices and APs) to work with the licensed users already occupying a band (e.g., the 6 GHz band), AFC was established. AFC is a spectrum use coordination system. For example, because the 6 GHz band was already occupied by incumbent users (i.e., Fixed Services (FS)), such as fixed satellite providers, restrictions may be placed on the Wi-Fi devices looking to transmit in this band. To avoid potential interference with existing 6 GHz incumbents, AFC may impose two types of device classifications with different transmit power rules for Wi-Fi devices operating on the band: i) low power APs for indoor Wi-Fi and ii) standard power APs that may be used indoors and outdoors.

As shown in FIG. 1, AFC 150 may provide spectrum use coordination for coverage environment 110. A transmitter 155 and a receiver 160 may comprise a licensed FS incumbent user. First AP 115, second AP 120, third AP 125, and fourth AP 130 may comprise unlicensed devices. AFC 150 may coordinate spectrum use between the licensed and unlicensed to avoid potential interference in coverage environment 110.

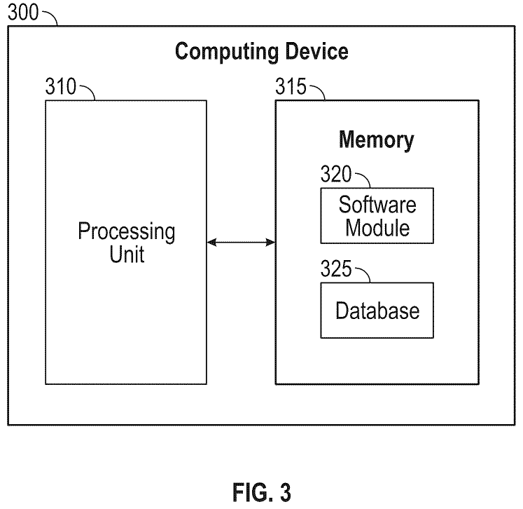

The elements described above of operating environment 100 (e.g., controller 105, first AP 115, second AP 120, third AP 125, fourth AP 130, first client device 135, second client device 140, or third client device 145) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

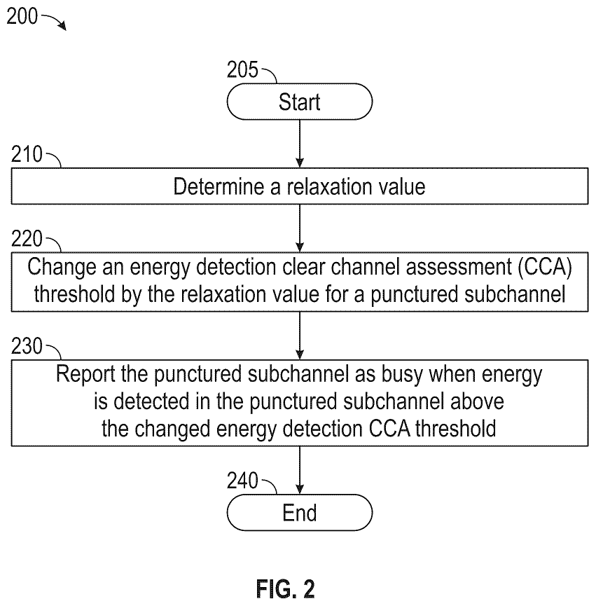

FIG. 2 is a flow chart setting forth the general stages involved in a method 200 consistent with embodiments of the disclosure for providing a Low Power Indoor (LPI) Access Point (AP) that punctures its channel while respecting incumbents. Method 200 may be implemented using computing device 300 as described in more detail below with respect to FIG. 3. Computing device 300 may be embodied by first AP 115 or first client device 135 for example. Ways to implement the stages of method 200 will be described in greater detail below.

Method 200 may begin at starting block 205 and proceed to stage 210 where computing device 300 may determine a relaxation value (e.g., X). For example, computing device 300 (e.g., first AP 115 or first client device 135) may perform CCA sensing over both punctured and unpunctured channels, except, if it can lower its emissions over a punctured channel by X dB, then it can relax (raise) its CCA threshold by X dB for that punctured channel. In various embodiments, X may be calculated as the min, mean-in-power, or mean-in-dB of the Transmit (TX) Power Spectral Density (PSD) suppression. In other words the relaxation value may comprise a minimum of an amount that computing device 300 can suppress its TX PSD for the punctured subchannel, a mean-in-power of the amount that computing device 300 can suppress its TX PSD for the punctured subchannel, or a mean-in-dB of the amount that computing device 300 can suppress its TX PSD for the punctured subchannel for example. Client devices and APs may signal to one another there capability to relax (raise) their CCA threshold by X dB for a punctured channel. The relaxed CCA threshold may be different for APs and client devices because regulators may want client devices to be more sensitive and provide less interference. Client devices and APs may also signal that they have regulatory permission to operate in an LPI BSS with punctured channels.

From stage 210, where computing device determines the relaxation value, method 200 may advance to stage 220 where computing device 300 may change an energy detection CCA threshold by the relaxation value for a punctured subchannel. In the aforementioned example, the punctured subchannel may comprise the S40a subchannel. For example, if the CCA threshold is [−62 −62 −62 −62] dBm for the corresponding subchannels, but computing device 300 can suppress its TX PSD by 20 dB (e.g., X) over the punctured subchannel, then computing device 300 may defer at [−62 −62 −42 −62] dBm for the corresponding subchannels. In other words, computing device 300 may change the energy detection CCA threshold of −62 dBm by the relaxation value of 20 dBm (e.g., X) for the S40a subchannel causing the energy detection CCA threshold to go from −62 dBm to −42 dBm for the S40a subchannel. It may remain at −62 dBm for the remaining subchannels.

Once computing device 300 changes the energy detection CCA threshold by the relaxation value for a punctured subchannel in stage 220, method 200 may continue to stage 230 where computing device 300 may report the punctured subchannel as busy when energy is detected in the punctured subchannel above the changed energy detection CCA threshold. For example, computing device 300 (e.g., first AP 115 or first client device 135) may perform CCA. With respect to the above example, computing device 300 may report the S40a subchannel as busy when energy is detected in the S40a subchannel above −42 dBm (i.e., the changed energy detection CCA threshold). Once computing device 300 reports the punctured subchannel as busy when energy is detected in the punctured subchannel above the changed energy detection CCA threshold in stage 230, method 200 may then end at stage 240.

Consistent with other embodiments, computing device 300 may perform CCA sensing over both punctured and unpunctured channels, except, if computing device 300 can lower its emissions over a punctured channel by X dB, then it can relax (raise) its CCA threshold by a factor (e.g., rho)*X dB for that punctured channel, where 0<rho<1. For example, using the above example, if rho=0.5, and the CCA threshold is [−62 −62 −62 −62] dBm, but the STA can suppress its TX PSD by 20 dB over the punctured channel, then the STA would defer at [−62 −62 −52 −62] dBm. In this example, the energy detection CCA threshold to go from −62 dBm to −52 dBm for the S40a subchannel.

Consistent with other embodiments of the disclosure, only clients that support this behavior may associate/operate at the full Bandwidth (BW) (that includes punctured channels); otherwise they may associate/operate at a lower BW (that is entirely unpunctured). Or the AP may enforce this requirement by rejecting association (or deauthorize, etc.) if client devices are incapable of this and try to associate/operate at the full BW (that includes punctured channels).

Consistent with other embodiments of the disclosure regulators may be soft on a 99% BW definition and may preferred a −26 dBm BW definition. But a −26 dBm mask may be a nonstarter and −20 dBm may be a better goal. This may lead to a refinement. Instead of calculating a new CCA threshold of −62+20=−42 dBm as described above, to meet (or satisfactorily approach) the regulator's preferred 26 dB requirement, rather change the −62 dBm nominal sensitivity to −62−(26−NotchDepth)=−88+NotchDepth=−68 dBm nominal sensitivity (for a notch depth of 20 dB), then do CCA on punctured channels at nominal sensitivity+NotchDepth=−68+20=−48 dBm. In other words, because the notch depth may be 6 dB higher than regulators might want, then make the CCA threshold 6 dB more sensitive. More generally, the CCA threshold may be S dB more sensitive, or it could be some proportion of that (e.g., rho*S for 0<rho<=1.)

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing a Low Power Indoor (LPI) Access Point (AP) that punctures its channel while respecting incumbents as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining, by a computing device, a relaxation value;
changing an energy detection Clear Channel Assessment (CCA) threshold by the relaxation value for a punctured subchannel; and
reporting the punctured subchannel as busy when energy is detected in the punctured subchannel above the changed energy detection CCA threshold.

2. The method of claim 1, wherein the relaxation value comprises a minimum of an amount that the computing device can suppress its Transmit (TX) Power Spectral Density (PSD) for the punctured subchannel.

3. The method of claim 1, wherein the relaxation value comprises a mean-in-power of an amount that the computing device can suppress its Transmit (TX) Power Spectral Density (PSD) for the punctured subchannel.

4. The method of claim 1, wherein the relaxation value comprises a mean-in-dB of an amount that the computing device can suppress its Transmit (TX) Power Spectral Density (PSD) for the punctured subchannel.

5. The method of claim 1, wherein determining the relaxation value further comprises multiplying the relaxation value by a factor between zero and one.

6. The method of claim 1, wherein the computing device comprises an Access Point (AP).

7. The method of claim 1, wherein the computing device comprises a client device.

8. A system comprising:
a memory storage; and
a processing unit disposed in a computing device coupled to the memory storage, wherein the processing unit is operative to:
determine a relaxation value;
change an energy detection Clear Channel Assessment (CCA) threshold by the relaxation value for a punctured subchannel; and
report the punctured subchannel as busy when energy is detected in the punctured subchannel above the changed energy detection CCA threshold.

9. The system of claim 8, wherein the relaxation value comprises a minimum of an amount that the computing device can suppress its Transmit (TX) Power Spectral Density (PSD) for the punctured subchannel.

10. The system of claim 8, wherein the relaxation value comprises a mean-in-power of an amount that the computing device can suppress its Transmit (TX) Power Spectral Density (PSD) for the punctured subchannel.

11. The system of claim 8, wherein the relaxation value comprises a mean-in-dB of an amount that the computing device can suppress its Transmit (TX) Power Spectral Density (PSD) for the punctured subchannel.

12. The system of claim 8, wherein the processing unit being operative to determine the relaxation value further comprises the processing unit being operative to multiply the relaxation value by a factor between zero and one.

13. The system of claim 8, wherein the computing device comprises an Access Point (AP).

14. The system of claim 8, wherein the computing device comprises a client device.

15. A non-transitory computer-readable medium that stores a set of instructions which when executed perform a method executed by the set of instructions comprising:
determining, by a computing device, a relaxation value;
changing an energy detection Clear Channel Assessment (CCA) threshold by the relaxation value for a punctured subchannel; and
reporting the punctured subchannel as busy when energy is detected in the punctured subchannel above the changed energy detection CCA threshold.

16. The non-transitory computer-readable medium of claim 15, wherein the relaxation value comprises a minimum of an amount that the computing device can suppress its Transmit (TX) Power Spectral Density (PSD) for the punctured subchannel.

17. The non-transitory computer-readable medium of claim 15, wherein the relaxation value comprises a mean-in-power of an amount that the computing device can suppress its Transmit (TX) Power Spectral Density (PSD) for the punctured subchannel.

18. The non-transitory computer-readable medium of claim 15, wherein the relaxation value comprises a mean-in-dB of an amount that the computing device can suppress its Transmit (TX) Power Spectral Density (PSD) for the punctured subchannel.

19. The non-transitory computer-readable medium of claim 15, wherein determining the relaxation value further comprises multiplying the relaxation value by a factor between zero and one.

20. The non-transitory computer-readable medium of claim 15, wherein the computing device comprises one of an Access Point (AP) and a client device.
